(19) United States
(12) Patent Application Publication
(10) Pub. No.: US 2016/0362193 A1
(43) Pub. Date: Dec. 15, 2016

(54) Aircraft propeller warning illuminator

(71) Applicant: Ian Gill Bemis, Bowie, MD (US)

(72) Inventor: Ian Gill Bemis, Bowie, MD (US)

(21) Appl. No.: 14/545,745

(22) Filed: Jun. 15, 2015

(51) Int. Cl. B64D 47/06; B64C 11/16

(52) U.S. Cl. CPC B64D 47/06; B64C 11/16

(57) ABSTRACT

An aircraft ground safety device that illuminates the blades of a spinning aircraft propeller with bright colored light in order to improve visual awareness of the danger zone created by an otherwise inviable propeller spinning at high RPM. The device consists of lighting fixtures (typically LEDs in the currently envisioned embodiment of the invention) mounted on the propeller blades of an aircraft that display the aircraft propeller as a brightly colored disk of light when the propellers are spinning, as well as an electrical power supply to the aforementioned lighting array, provided by a slip ring connector and powered by the by the electrical system of the aircraft. The lighting array is intended to activate whenever the blades are in motion to further the aim of safety in aviation.

### INVENTION BACKGROUND

1. Field of the Invention

The invention to be described, illustrated, and documented herein consists of a means by which an aircraft propeller spinning at high RPM (which is largely invisible to the human eye do to the stroboscopic effect) may be brightly illuminated (the timing of which may be controlled as described herein) as to create an obvious visual precaution against serious injury or death that may result in the event of direct human contact with the spinning propeller of a piston engine, turbo propeller, or other aircraft.

2. Description of Related Art

Beginning with the first powered flight by the Orville and Wilbur Wright, artificial air transportation has primarily focused on heavier than air travel, where a fixed wing or rotary wing aircraft artificially generates thrust necessary for ascension and sustenance of altitude. This is typically achieved by means of an internal combustion engine (of piston or turbine design) transferring energy through a airfoil propeller fan blade rotating at high speeds to generate a pressure differential (lift) under the wing of the aircraft by means of inducing forward movement of the aircraft commonly described as thrust. Later rotary winged aircraft (helicopters) were devised and constructed which generate lift by direct action of an overhead wing (functionally similar to both a airfoil wing and a airfoil fan blade propeller) rotating under power of a motor, which directly acts upon the air and is capable of producing enough lift to sustain flight at low speeds or while stationary. Improvements to the design of aircraft propellers have largely focused around the goal of improving the efficiency at which they generate lift/forward thrust by means of the geometric modification of the propeller configuration, as well as modifications to the basic design of the propeller to adapt its use to new propulsion systems such as turbo propeller or turbo jet aircraft. This system of propulsion by means of a conspicuous external fan blade rotating at high speeds is, however necessary for human manned and unmanned air travel, inherently dangerous in the sense that the spinning propeller is extremely hazardous to any bystanders, pilots, passengers, airport/service personnel or ground crews servicing or refueling the aircraft. Early attempts by propeller manufacturers to solve the problem of propeller invisibility appeared in the form of brightly colored and spaced paint schemes, which marginally enhance the visibility of the propeller when rotating at high RPM.

### BRIEF DESCRIPTION OF THE INVENTION

The invention described, illustrated, and documented herein is a new and innovative improvement to aircraft ground safety, as it is designed to improve visual awareness to the danger zone created by an aircraft propeller rotating at high RPM. The device incorporates several light fixtures (typically LEDs) in the blades and other components of an aircraft propeller, which when illuminated, Persistence of Vision will cause the spinning propeller blade to become visible as a brightly displayed disk of light, greatly reducing the chances of accidental injury or death, which may result from personal contact with a rotating propeller blade. Electrical power to the electronic lighting fixtures, mounted on the propeller, is provided by a slip ring connector typically mounted around the axis of the propeller shaft, to provide electrical current without interference with the rotation of the propeller(s) and shaft(s). The brightness of the lighted propeller may be adjusted manually by a pilot/operator accessible potentiometer, limiting the electrical current supplied to the lighting fixtures mounted on the propeller blades.

### DETAILED DESCRIPTION OF THE INVENTION

The invention described, illustrated, and documented herein is a new and innovative improvement to aircraft ground safety, as it is designed to improve visual awareness to the danger zone created by an aircraft propeller rotating at high RPM.

As noted previously, the invention incorporates several light fixtures (light emitting diodes of colored visible spectrum such as red, green, blue or violet in order to enhance visual recognition of the danger zone created by the spinning propeller in the currently envisioned embodiment of the invention) mounted along the central axis of the propeller blades, extending from the axis of the propeller to the tip of the propeller. The electrically conductive wiring is manufactured integral to the body and blades of the propeller in the currently envisioned embodiment, in order to preserve aerodynamic efficiency and propeller balance.

Power is supplied to the lighting fixtures on the propeller(s) by (in the currently envisioned embodiment of the invention) a slip ring connector (or similar device) manufactured to sufficient specifications to handle the range of RPMs encountered by an aircraft propeller shaft operating under normal conditions of the particular aircraft design. In the currently envisioned embodiment, the slip ring connector will be of “trough hole” design, to be mounted around the axis of the propeller shaft, in the immediate posterior of the propeller.

Electrically conductive wiring, supplying power to the aforementioned lighting array through means of the slip ring connector (or similar device) in the currently envisioned embodiment of the invention that will attach to the slip ring connector, will (in the currently envisioned embodiment of the invention) attach to the main electrical exterior safety/visibility lighting system of the aircraft. Electrical current to the aforementioned lighting array, may be controlled by a electrical switch either separate to or on an adjacent circuit to the pilot/operator accessible controls which control current flow to other safety/visibility exterior lighting on an aircraft. The flow of electric current to the aforementioned lighting system will be controlled in the currently envisioned embodiment of the invention, by a pilot/operator accessible potentiometer mounted on the control panel of the aircraft, thus allowing the pilot/operator to manually adjust the brightness of the lighting array on the aircraft propeller(s). In the currently envisioned embodiment of the invention, the propeller(s) are illuminated whenever the engines are running, and the blades turning, in order to best fulfill the safety intent of this invention.

### BRIEF DESCRIPTION OF THE DRAWINGS DEPICTED

The illustrations and diagrams of the invention in its intended application(s) provided within this document correspond to an enumerated description below, in order to aid the reader in ascertaining a clear and comprehensive understanding of the nature and function of the invention. Nothing described or depicted herein should be construed as to limit the useful scope of the invention or diminish the utility of the invention to an application or configuration other than as in the context as it is described below, as pertaining to certain applications illustrated within this document.

In accordance with the above statement, the description(s) are as follows:

FIG. 1: A two dimensional illustration of a component of the invention consisting of a stationary aircraft propeller, with lighting fixture(s) mounted to any one blade.

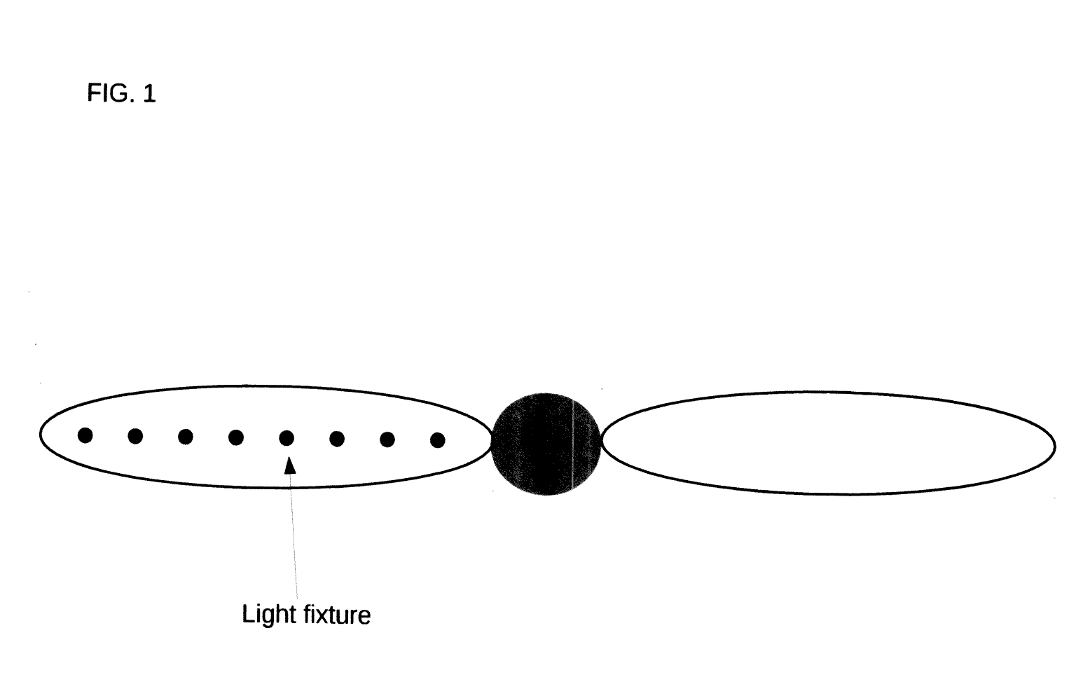

FIG. 2: A two dimensional illustration of a component of the invention consisting of a stationary aircraft propeller, with lighting fixture(s) mounted to one blade, with a second series of lighting fixture(s) mounted on a subsequent blade in a manner which may correspond to the arrangement of the lighting fixture(s) on the first blade

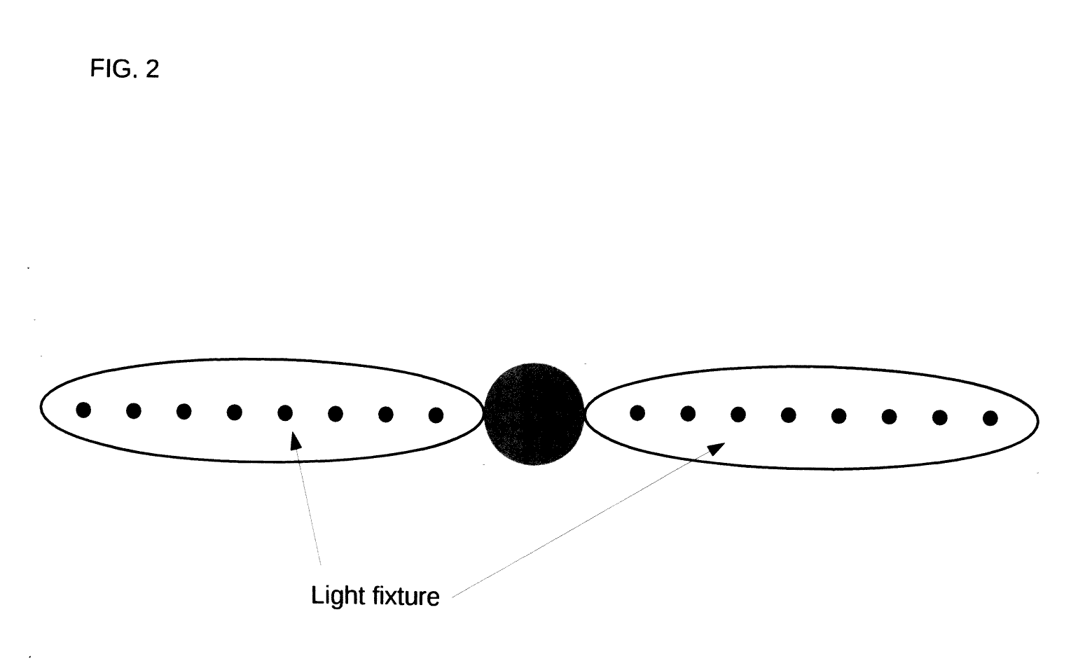

FIG. 3: A two dimensional illustration of a component of the invention consisting of an aircraft propeller with lighting fixture(s) as depicted in FIGS. 1 and 2, showing the path of rotation of the lighting fixtures (shown as a dotted line) as corresponds with the position of the lighting fixtures on any number of blades

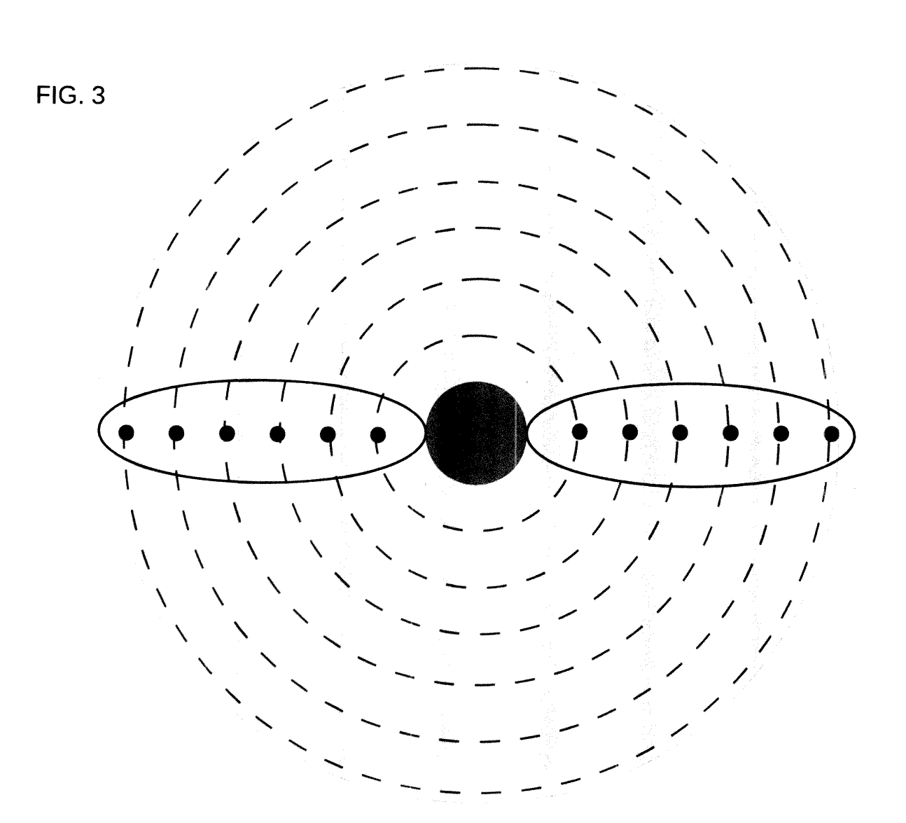

FIG. 4: A three dimensional illustration of an aircraft propeller with lighting fixture(s) as depicted in FIGS. 1 and 2 attached to the propeller shaft assembly, with a through hole slip ring connector mounted around the axis of the propeller shaft in order to provide electrical power to the aforementioned lighting fixtures, with external wiring shown and labeled. Not shown is the wiring integral to the body of the propeller(s) and blades of the propellers. The component parts of the mounted propeller as attached to the shaft assembly are labeled for the convenience of the viewer.

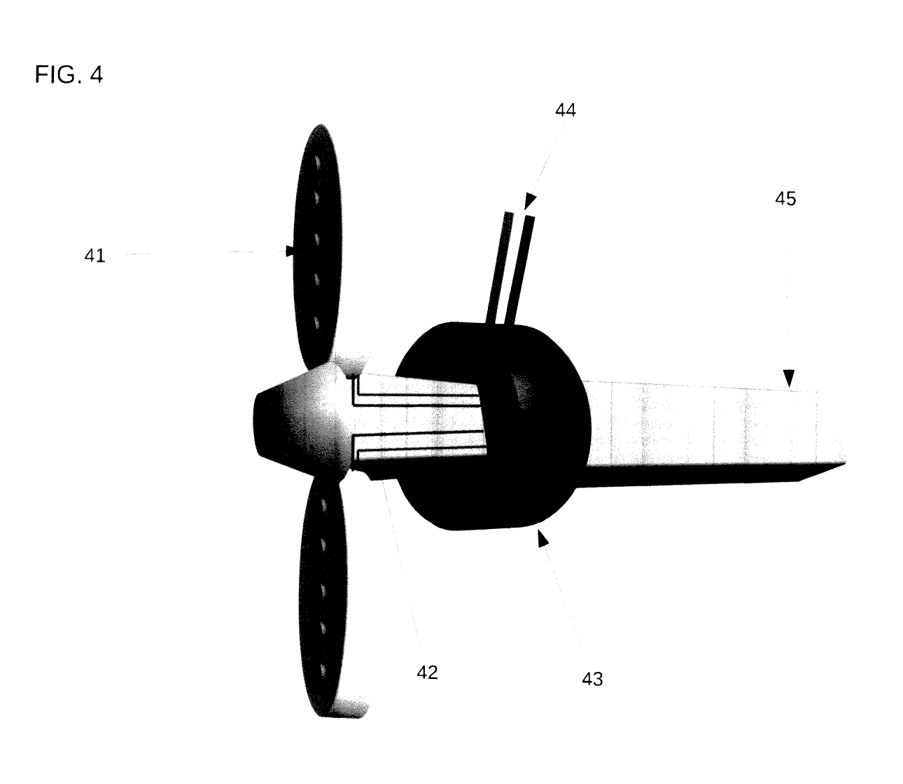

### REFERENCE NUMERALS WITH REGARD TO FIG. 4:

41: Each dot represents a lighting fixture
42: Wires from slip ring connector to propeller lighting fixtures
43: Through hole slip ring connector
44: Wires supplying power to slip ring connector
45: Propeller shaft

1) an electronic means of illuminating the propeller(s) of an aircraft, to enhance the visibility of the rotating propeller(s) to the naked eye of an observer by means of electronic lighting, typically constructed with light emitting diodes (LED) affixed centrally to the outward portion of the blades(s) typically mounted in-line intersecting at the axis hub of the propeller, which may incorporate a congruent arrangement on both sides of the propeller(s), the flow of electricity to the aforementioned lighting arrangement being controlled by a pilot/operator accessible switch typically located in the cockpit of the aircraft.

2) an electronic switch which allows current flow to the illuminated propeller as described in the previous claim automatically, when the propeller is in motion

3) a slip ring electrical connector or any device of similar function, design, or purpose when mounted or utilized in a manner which to allow for the flow of electrical current to and from the fuselage of an aircraft to the propeller(s) of an aircraft
